(19) United States
(12) Patent Application Publication
(10) Pub. No.: US 2024/0376568 A1
(43) Pub. Date: Nov. 14, 2024

(54) EFFICIENT RARE EARTH AND CRITICAL MATERIAL RECOVERY FROM RARE EARTH MAGNETS

(71) Applicant: Battelle Memorial Institute, Columbus, OH (US)

(72) Inventors: Morgan V. EVANS, Columbus, OH (US); Devin DICKSON, Columbus, OH (US); Hong Be TRUONG, Lewis Center, OH (US); Erica HOWARD, Columbus, OH (US)

(21) Appl. No.: 18/660,071

(22) Filed: May 9, 2024

Related U.S. Application Data
(60) Provisional application No. 63/501,407, filed on May 11, 2023.

(51) Int. Cl. C22B 59/00; C22B 1/24; C22B 3/44; C22B 7/00

(52) U.S. Cl. CPC C22B 59/00; C22B 1/24; C22B 3/44; C22B 7/007

(57) ABSTRACT

In an approach to efficient rare earth and critical material recovery from rare earth magnets, a process includes demagnetizing the rare earth magnets, breaking the rare earth magnets, leaching the rare earth magnets to extract rare earth element phosphates, and precipitating the rare earth magnets to extract rare earth element sulfates.

### CROSS-REFERENCE TO RELATED APPLICATIONS

The present application claims the benefit of the filing date of U.S. Provisional Application Ser. No. 63/501,407, filed May 11, 2023, the entire teachings of which application is hereby incorporated herein by reference.

### TECHNICAL FIELD

The present application relates generally to critical material recovery and, more particularly, to efficient rare earth and critical material recovery from rare earth magnets.

### BACKGROUND

A neodymium magnet (NdFeB) is a widely used type of rare earth magnet. It is a permanent magnet typically made from an alloy of neodymium (Nd), iron (Fe), and boron (B). Rare earth magnets are generally considered the strongest type of permanent magnet available commercially. They have replaced other types of magnets in many applications in modern products that require strong permanent magnets, such as hard disk drives. In addition to hard disk drives, rare earth magnets are used in applications ranging from door latches to medical devices, including loudspeakers, cordless tools, motors, and generators.

### BRIEF DESCRIPTION OF THE DRAWINGS

Reference should be made to the following detailed description which should be read in conjunction with the following figures, wherein like numerals represent like parts.

FIG. 1 is one illustrative example embodiment of a process for efficient rare earth and critical material recovery from rare earth magnets, consistent with the present disclosure.

FIG. 2 is an illustrative example flow diagram of a four-step process for the efficient rare earth and critical material recovery from rare earth magnets of FIG. 1, consistent with the present disclosure.

FIG. 3A is a chart illustrating an example of the yields of both solids and liquids from the process of FIG. 2, consistent with the present disclosure.

FIG. 3B is a detail from the example chart of FIG. 2A, illustrating the yields of only the solids from the process of FIG. 2, consistent with the present disclosure.

FIG. 4 is an illustrative example embodiment of a processing stream for efficient rare earth and critical material recovery from rare earth magnets, consistent with the present disclosure.

FIGS. 5A, 5B, 5C, and 5D is another illustrative example flow diagram of the four-step process for efficient rare earth and critical material recovery from rare earth magnets of FIG. 2, consistent with the present disclosure.

FIG. 6 illustrates example charts of results for each leaching step in the four-step process of FIGS. 5A-5D.

FIG. 7 is a table of total recovery of rare earth elements (REEs), consistent with present disclosure.

FIGS. 8A, 8B, and 8C are an illustrative flow diagram of one example embodiment of a three-step process for efficient rare earth and critical material recovery from rare earth magnets, consistent with the present disclosure.

FIG. 9 is an example chart of results three-step process of FIGS. 8A-8C.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Both green energy technologies and defense capabilities require permanent magnets which are largely comprised of critical materials including REEs, cobalt (Co), nickel (Ni) and boron. These elements are desired for a wide variety of technologies including use in batteries, magnets, lighting, and catalysis. While these elements are not rare in the Earth's crust, they are often geopolitically constrained, and difficult and expensive to mine. As a result, the market is primarily dominated by foreign suppliers that control the world supply of these metals. Recycling is a crucial strategy to enable a domestic market capable of producing a long-term supply of these elements. Currently end of life recycling rates using traditional industrial scale hydrometallurgical techniques are not abundant for high value critical minerals. There is an exigent need to establish economically viable and environmentally friendly processes for recycling these materials.

The critical material recovery process disclosed herein enables high efficiency, high purity recovery of REEs and other critical materials from permanent magnets. The disclosed recovery technology takes a hydrometallurgical approach and removes multiple energy-intensive processing steps to reduce energy input without reduction in efficiency or recovery of critical metals from permanent magnets. The disclosed process removes grinding or milling, oxidation or roasting, and implements an early-stage removal of iron step using mild acids. Omitting both milling/grinding and any calcination/roasting steps lowers both capital and operating expenses. Furthermore, this process can be readily deployed in existing hydrometallurgy plants enabling faster deployment of technology with lower cost and energy requirements than traditional hydrometallurgical techniques.

The disclosed process recovers magnet REEs, such as Nd, dysprosium (Dy), and praseodymium (Pr), in proportions needed for downstream manufacturing, alongside cobalt, copper, and nickel, which are also considered critical by the United States Geological Survey (USGS). The disclosed process recovers high purity rare earth oxides in proportions that can be fed into new magnet alloying streams. Additionally, nickel, cobalt, and copper are recovered as saleable products to offset the shifting market prices of rare earth oxides. Nickel is recovered as a solid metal, whereas cobalt and copper are recovered as salts or oxides. The disclosed process can be used to produce rare earth salts or be combined with oxalic acid precipitation and calcination to produce rare earth oxides. The disclosed process offers an environmentally friendly, inexpensive recycling technique for selective separation of REEs and critical minerals.

In an embodiment, a four step process may be used for efficient rare earth and critical material recovery from rare earth magnets. In the first step, the permanent magnet, e.g., a neodymium magnet, is demagnetized and broken, typically by using a hydraulic press. Next, the demagnetized, broken magnet particles are digested in phosphoric acid to precipitate out REEs while solubilizing iron. The precipitated REE-phosphates are then leached using sulfuric acid, and finally the REE sulfates are precipitated using sodium hydroxide (NaOH).

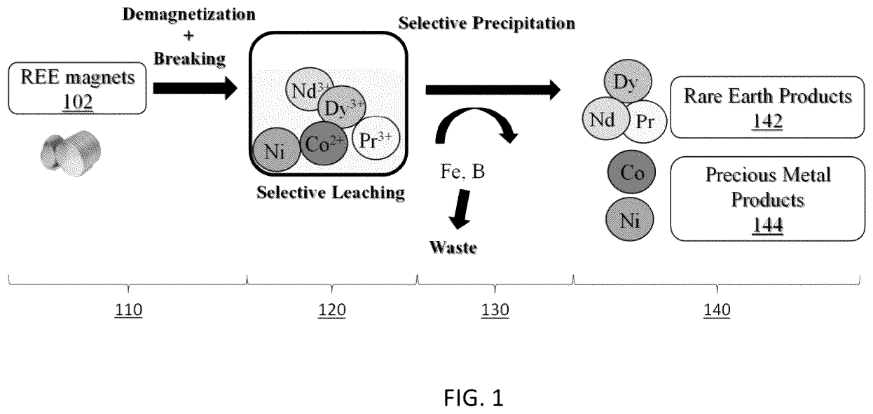

FIG. 1 is one illustrative example embodiment of a process for efficient rare earth and critical material recovery from rare earth magnets, consistent with the present disclosure. In the example of FIG. 1, the REE magnets 102, e.g., neodymium magnets or samarium cobalt magnets, are demagnetized and broken in operation 110. Selective leaching In operation 120 and selective precipitation in operation 130 result in extraction of metals such as Ni, B, and Fe. Finally, in operation 140 rare earth products 142 and precious metal products 144 are extracted.

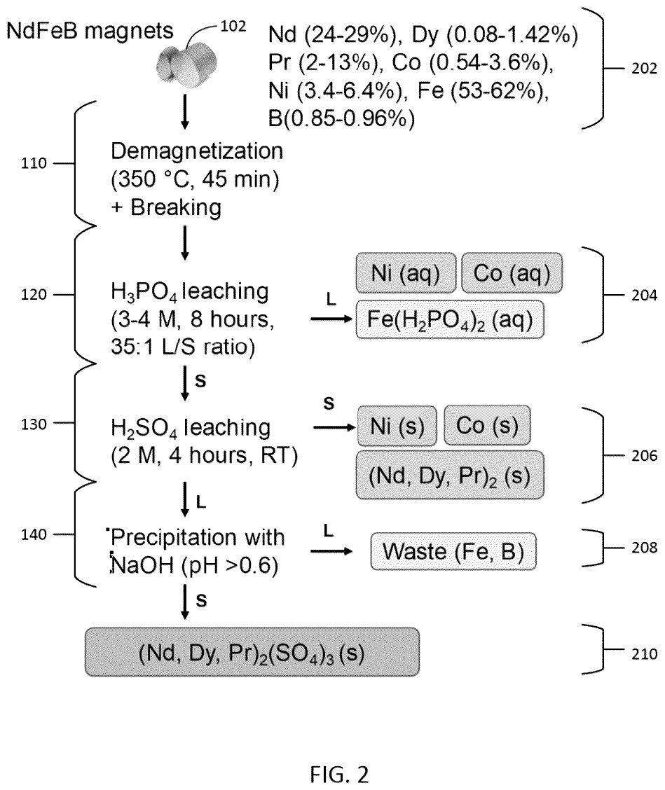

FIG. 2 is an illustrative example flow diagram of a four-step process for the efficient rare earth and critical material recovery from rare earth magnets of FIG. 1. As mentioned above in FIG. 1, in operation 110, REE magnets 102 are demagnetized and broken. This process may include demagnetization at a predetermined temperature for a first predetermined period of time. In an embodiment, the predetermined temperature for demagnetization may be in the range of 350 degrees Celsius (C) to 450° C., inclusive, for example, the predetermined temperature may be 350° C. In an embodiment, the first predetermined period of time may be in the range of 0.5 hours to 3.0 hours, inclusive, for example, the first predetermined period of time for demagnetization may be 45 minutes. Following the demagnetization, the REE magnets 102 are broken.

As shown in contents 202, the REE magnets 102 may consist of many useful chemicals. These chemicals may include Nd (24-29%), Dy (0.08-1.42%), Pr (2-13%), Co (0.54-3.6%), Ni (3.4-6.4%), Fe (53-62%), and B (0.8 5-0.96%). The number shown in parentheses for each chemical represents that chemical's typical percentage of the mass of the REE magnets.

In operation 120, the broken magnets may be leached in a solution of phosphoric acid (H₃PO₄) for a second predetermined period of time. In an embodiment, the solution of phosphoric acid may be in a first predetermined molar range of 2-4 molar (M). In an embodiment, the second predetermined period of time for leaching the rare earth magnets in phosphoric acid may be in the range of 1-96 hours, inclusive, for example, the second predetermined period of time may be 8 hours.

In an embodiment, leaching the rare earth magnets in phosphoric acid may use a predetermined liquid/solid ratio in the range of 30:1 to 35:1, e.g., 35:1. The output 204 of the leaching operation 120 may include the extraction of liquids such as aqueous nickel, aqueous copper, and aqueous iron (II) dihydrogen phosphate (Fe(H₂PO₄)₂).

In operation 130, the residual output from operation 120 may be further leached in an acid, for example, sulfuric acid (H₂SO₄), for a third predetermined period of time. In an embodiment, the solution of sulfuric acid may be in a second predetermined molar range of 2-4 M, inclusive. In an embodiment, the third predetermined period of time for leaching the rare earth magnets in sulfuric acid may be in the range of 1-8 hours, inclusive, for example, the third predetermined period of time may be 4 hours. In an embodiment, the solution of sulfuric acid may be at room temperature for the leaching operation 130. As used herein, the term “room temperature” denotes a temperature in the range of 18° C. to 25° C., inclusive. The output 206 of the leaching operation 130 may include the extraction of solids such as nickel, copper, and neodymium, dysprosium, and praseodymium.

Finally, in precipitation operation 140 the remaining material may be combined with NaOH causing precipitation of the output 210 of solid neodymium(III) sulfate, dysprosium(III) sulfate, and prascodymium (III) sulfate ((Nd, Dy, Pr)₂(SO₄)₃), and waste liquid 208, which includes iron and boron. In an embodiment, in precipitation operation 140 the sodium hydroxide is added to bring the sulfuric acid solution pH above 2.

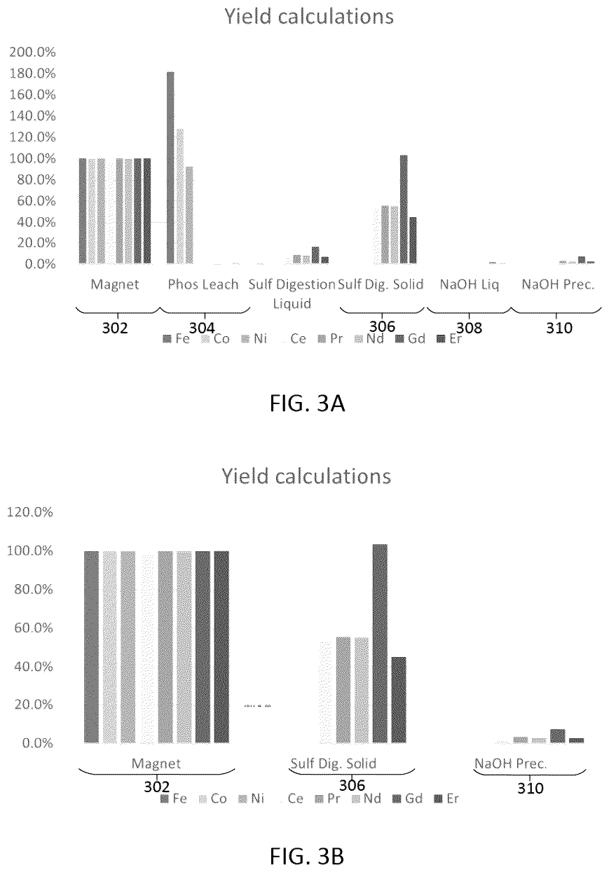

FIG. 3A is a chart illustrating an example of the yields of both solids and liquids from the process of FIG. 2. In the example of FIG. 3A, yields are displayed for the content of the magnet as well as the various output stages. Magnet 302 is the example content of the magnet being recycled. This corresponds to the contents 202 of the REE magnets 102 of FIG. 2. The phosphate leach output 304 corresponds to the output 204 of FIG. 2. The sulphate solids 306 corresponds to the output 206 of FIG. 2. Finally, the sodium hydroxide liquid 308 corresponds to the waste liquid 208 of FIG. 2, while the sodium hydroxide precipitation 310 corresponds to the solid output 210 of FIG. 2.

FIG. 3B is a detail from the example chart of FIG. 3A, illustrating the yields of only the solids from the process of FIG. 2. As in the example of FIG. 3A, yields are displayed in the example of FIG. 3B for the content of the magnet but only the solids from the various output stages. Magnet 302 is the example content of the magnet being recycled. The sulphate solids 306 corresponds to the output 206 of FIG. 2. Finally, the sodium hydroxide precipitation 310 corresponds to the solid output 210 of FIG. 2. FIG. 3B is provided to show details of the most important materials recovered in the process.

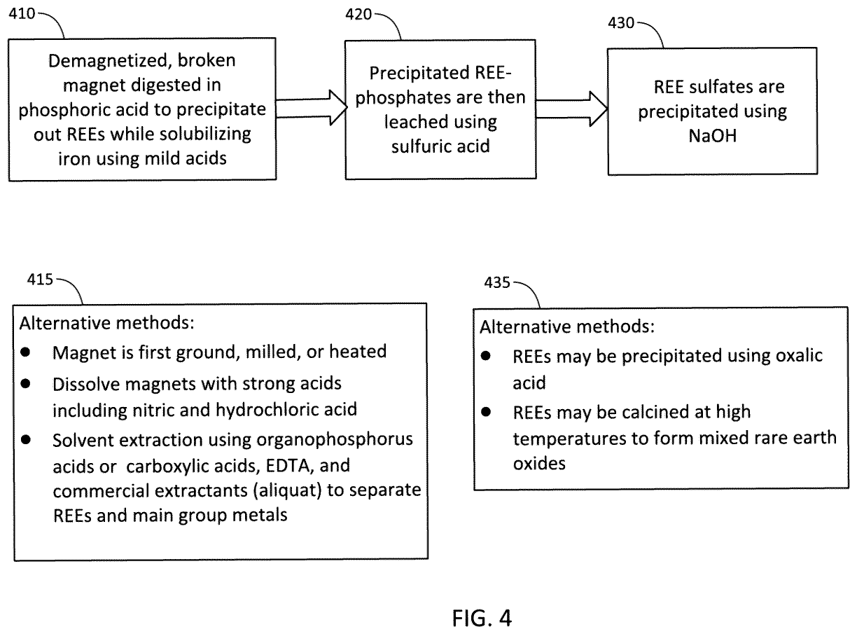

FIG. 4 is an illustrative example embodiment of a processing stream for efficient rare earth and critical material recovery from rare earth magnets, consistent with the present disclosure.

In the illustrative embodiment of FIG. 4, the magnet to be recycled is demagnetized and the broken magnet is digested in phosphoric acid to precipitate out the REEs while solubilizing iron using mild acids in operation 410.

Alternative methods to operation 410 are shown in operation 415. These may include first grinding, milling, or heating the magnet; dissolving the magnets with strong acids, e.g., nitric acid and hydrochloric acid; solvent extraction using organophosphorus acids or carboxylic acids, ethylenediaminetetraacetic acid (EDTA), and commercial extractants, e.g., Aliquat, to separate REEs and main group metals.

In operation 420, precipitated REE-phosphates are then leached using sulfuric acid.

In operation 430, REE sulfates are precipitated using sodium hydroxide.

Alternative methods to operation 430 are shown in operation 435. These may include precipitating the REEs using oxalic acid; or calcining the REEs at high temperatures to form mixed rare earth oxides.

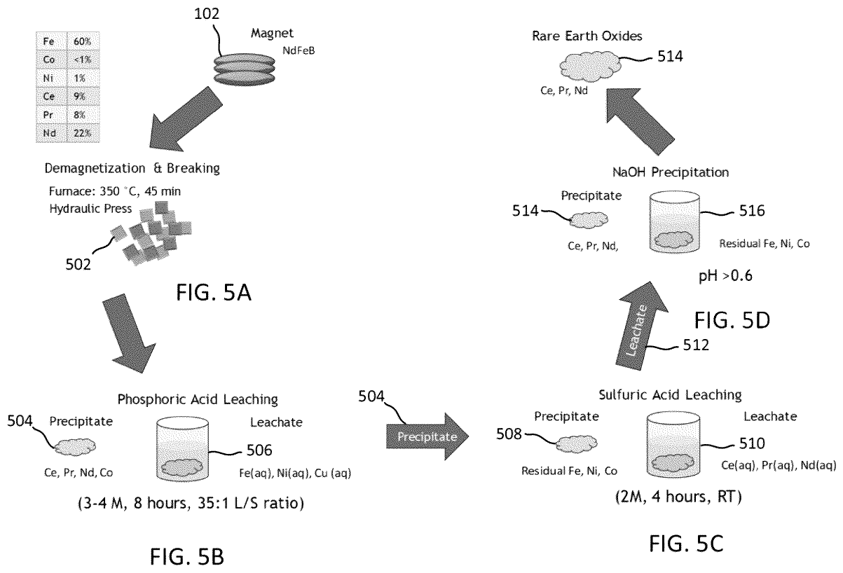

FIGS. 5A, 5B, 5C, and 5D is another illustrative example flow diagram of the four-step process for efficient rare earth and critical material recovery from rare earth magnets of FIG. 2, consistent with the present disclosure.

FIG. 5A illustrates the demagnetization and breaking of the REE magnets 102. In the example of FIG. 5A, the REE magnets 102 are neodymium magnets having a composition by mass of 60% Fe, <1% Co, 1% Ni, 9% cerium (Ce), 8% Pr, and 22% Nd. In an embodiment, the predetermined temperature for demagnetization may be in the range of 350° C. to 450° C., inclusive. In an embodiment, the predetermined period of time for demagnetization may be in the range of 0.5 hours to 3.0 hours, inclusive. In this example, the REE magnets 102 are demagnetized in a furnace at 350° C. for about 45 minutes. The REE magnets 102 are then broken in a hydraulic press into particles 502.

FIG. 5B illustrates the phosphoric acid leaching of the broken magnet particles 502. The phosphoric acid leaching precipitates out rare earth elements while also solubilizing iron. In an embodiment, the solution of phosphoric acid may be in a first predetermined molar range of 2-4 M. In an embodiment, the second predetermined period of time for leaching the rare earth magnets in phosphoric acid may be in the range of 1-96 hours, inclusive. In an embodiment, leaching the rare earth magnets in phosphoric acid may use a predetermined liquid/solid ratio in the range of 30:1 to 35:1, e.g., 35:1. In the example of FIG. 5B, the broken magnet particles 502 are leached in a 3-4 M phosphoric acid solution 506 at a liquid to solid ratio of about 35:1 for about 8 hours. The result of the leaching is precipitate 504, which in the example of FIG. 5B includes Ce, Pr, Nd, and Co, while the leachate includes aqueous Fe, Ni, and Cu.

FIG. 5C illustrates the sulfuric acid leaching of the precipitate 504 from the phosphoric acid leaching of FIG. 5B. In an embodiment, the solution of sulfuric acid may be in a second predetermined molar range of 2-4 M, inclusive. In an embodiment, the third predetermined period of time for leaching the rare earth magnets in sulfuric acid may be in the range of 1-8 hours, inclusive. In the example of FIG. 5C, the precipitate 504 is leached in a 2-4 M sulfuric acid solution 510 for about 4 hours at room temperature. The sulfuric acid leaching results in a precipitate 508 which includes residual Fe, Ni, and Co, as well as leachate 512 containing aqueous Ce, Pr, and Nd.

FIG. 5D illustrates the sodium hydroxide precipitation of the leachate 512 from the sulfuric acid leaching of FIG. 5C. The leachate 512 is precipitated in a sodium hydroxide solution 516 with a pH greater than 0.6. The precipitate 514 contains the rare earth oxides of Ce, Pr, and Nd, with the residual Fe, Ni, and Co remaining in the sodium hydroxide solution 516.

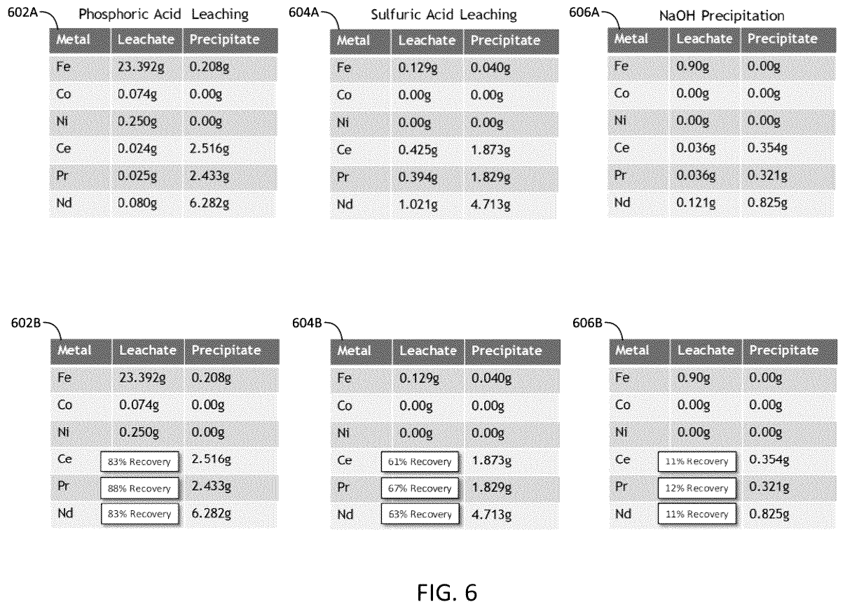

FIG. 6 illustrates example charts of results for each leaching step in the four-step process of FIGS. 5A-5D. For the example of FIG. 6, the weight of the starting material was approximately 34 g. Result chart 602A, result chart 604A, and result chart 606A show the results of the phosphoric acid leaching of FIG. 5B, the sulfuric acid leaching of FIG. 5C, and the sodium hydroxide precipitation of FIG. 5C, respectively. Result chart 602B, result chart 604B, and result chart 606B show the percentage of recovery of the REEs Ce, Pr, and Nd for the result chart 602A, 604A, and 606A, respectively.

The result chart 602B shows that the phosphoric acid leaching of FIG. 5B results in up to 83% recovery of Ce (2.516 g), up to 88% recovery of Pr (2.433 g), and up to 83% recovery of Nd (6.282 g). The result chart 604B shows that the sulfuric acid leaching of FIG. 5C results in up to 61% recovery of Ce (1.873 g), up to 67% recovery of Pr (1.829 g), and up to 63% recovery of Nd (4.713 g). The result chart 606B shows that the sodium hydroxide precipitation of FIG. 5C results in up to 11% recovery of Ce (0.354 g), up to 12% recovery of Pr (0.321 g), and up to 11% recovery of Nd (0.825 g).

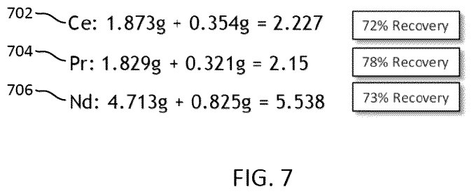

FIG. 7 is a table of total recovery of REEs, consistent with present disclosure. The total recovery illustrated in FIG. 7 includes precipitate from sulfuric acid leaching and sodium hydroxide precipitation. The process loses efficacy at the sulfuric acid leaching operation due to difficulty dissolving rare earth phosphates in sulfuric acid. As can be seen in FIG. 7, the total recovery for Ce is 1.873 g from the sulfuric acid leaching and 0.354 g for the sodium hydroxide precipitation, for a total Ce recovery of 2.227 g (72% recovery). The total recovery for Pr is 1.829 g from the sulfuric acid leaching and 0.321 g for the sodium hydroxide precipitation, for a total Pr recovery of 2.150 g (78% recovery). The total recovery for Nd is 4.713 g from the sulfuric acid leaching and 0.825 g for the sodium hydroxide precipitation, for a total Pr recovery of 5.538 g (73% recovery).

In an embodiment, a three step process may be used for efficient rare earth and critical material recovery from rare earth magnets. The three step process may improve the results from the four-step process of FIGS. 5A-5D to achieve REE oxide recovery rates greater than 70%, with recovery of REE-phosphates from using only the first three seps of the process being greater than 80%. Further adjustments to the chemistry of the fourth step of FIG. 5D, however, are expected to yield recovery rates of greater than 80% recovery of REE oxides.

In the first step, the permanent magnet, e.g., a neodymium magnet, is demagnetized. The REE magnets are then broken into particles. Finally, the demagnetized magnet particles are digested in phosphoric acid to precipitate out REEs while solubilizing iron.

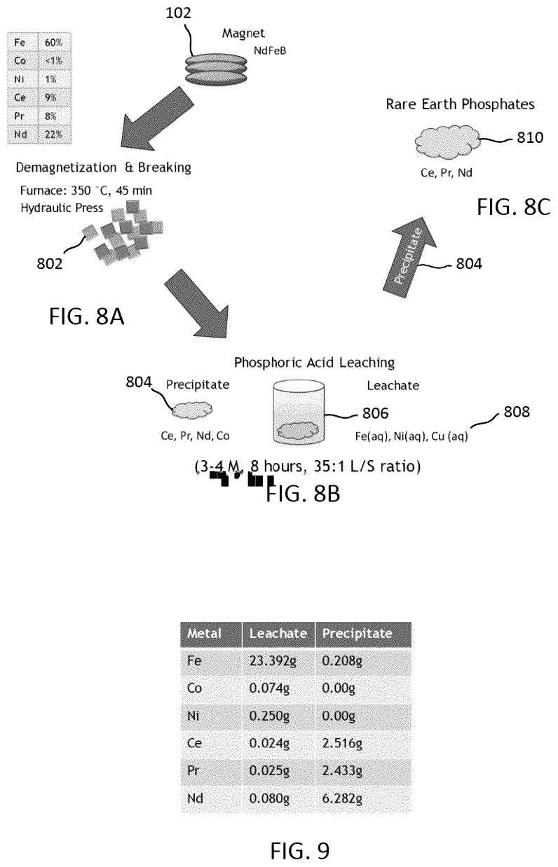

FIGS. 8A, 8B, and 8C are an illustrative flow diagram of one example embodiment of the three-step process for efficient rare earth and critical material recovery from rare earth magnets, consistent with the present disclosure. The four step process of FIGS. 5A-5D is effective to recover greater than 70% of the REEs expected in neodymium magnets. In the three step process, however, by removing the final leaching and precipitation steps, the yield is improved by approximately 10%.

FIG. 8A, as in FIG. 5A, illustrates the demagnetization and breaking of the REE magnets 102. In the example of FIG. 8A, the REE magnets 102 are neodymium magnets having a composition by mass of 60% Fe, <1% Co, 1% Ni, 9% Ce, 8% Pr, and 22% Nd. In an embodiment, the predetermined temperature for demagnetization may be in the range of 350° C. to 450° C., inclusive. In an embodiment, the predetermined period of time for demagnetization may be in the range of 0.5 hours to 3.0 hours, inclusive. In this example, the REE magnets 102 are demagnetized in a furnace at 350° C. for about 45 minutes. The REE magnets 102 are then broken in a hydraulic press into particles 802.

FIG. 8B, as in FIG. 5B, illustrates the phosphoric acid leaching of the broken magnet particles 802. The phosphoric acid leaching precipitates out rare earth elements while also solubilizing iron. In an embodiment, the solution of phosphoric acid may be in a first predetermined molar range of 2-4 M. In an embodiment, the second predetermined period of time for leaching the rare earth magnets in phosphoric acid may be in the range of 1-96 hours, inclusive. In an embodiment, leaching the rare earth magnets in phosphoric acid may use a predetermined liquid/solid ratio in the range of 30:1 to 35:1, e.g., 35:1. In the example of FIG. 8B, the broken magnet particles 802 are leached in a 3-4 M phosphoric acid solution 806 at a liquid to solid ratio of about 35:1 for about 8 hours. The result of the leaching is precipitate 804, which in the example of FIG. 8B includes Ce, Pr, Nd, and Co, while the leachate 808 includes aqueous Fe, Ni, and Cu.

In the example of FIG. 8C, the precipitated REE-phosphates may be converted to oxides by heating with sodium carbonate to yield the rare earth oxides. In an embodiment, the precipitated REE-phosphates may be heated to 500° C. to 1300° C. to convert the phosphates into oxides. Here the precipitate 804 contains the rare earth phosphates 810, which include Ce, Pr, and Nd.

FIG. 9 is an example chart of results three-step process of FIGS. 8A-8C. As shown in FIG. 9, the three-step process of FIGS. 8A-8C result in an 83% recovery for Ce, an 88% recovery for Pr, and an 83% recovery for Nd, all without the additional precipitation step of the four-step process of FIGS. 5A-5D.

According to one aspect of the disclosure there is thus provided a process for efficient rare earth and critical material recovery from rare earth magnets. The process includes demagnetizing the rare earth magnets, breaking the rare earth magnets, leaching the rare earth magnets to extract rare earth element phosphates, and precipitating the rare earth magnets to extract rare earth element sulfates.

According to another aspect of the disclosure, there is provided a process for efficient rare earth and critical material recovery from rare earth magnets. The process includes demagnetizing the rare earth magnets, breaking the rare earth magnets, and leaching the rare earth magnets to extract rare earth element phosphates.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A process for efficient rare earth and critical material recovery from rare earth magnets, the process comprising:
demagnetizing the rare earth magnets;
breaking the rare earth magnets;
leaching the rare earth magnets to extract rare earth element phosphates; and
precipitating the rare earth magnets to extract rare earth element sulfates.

2. The process of claim 1, wherein demagnetizing the rare earth magnets comprises heating the rare earth magnets to a temperature between 350 degrees Celsius (° C.) to 450° C. for 0.5-3.0 hours.

3. The process of claim 1, wherein demagnetizing the rare earth magnets further comprises:
grinding or milling the rare earth magnets prior to demagnetizing the rare earth magnets.

4. The process of claim 1, wherein breaking the rare earth magnets comprises breaking the rare earth magnets with a hydraulic press.

5. The process of claim 1, wherein breaking the rare earth magnets further comprises at least one of grinding and milling the rare earth magnets.

6. The process of claim 1, wherein leaching the rare earth magnets to extract the rare earth element phosphates further comprises:
leaching the rare earth magnets in a phosphoric acid solution for 1-96 hours; and
leaching the rare earth magnets in a sulfuric acid solution for 1-8 hours.

7. The process of claim 6, wherein the phosphoric acid solution is 2-4 molar (M) and at a liquid/solid ratio in the range of 30:1 to 35:1.

8. The process of claim 6, wherein the sulfuric acid solution is 2-4 M and a temperature of 18° C. to 25° C.

9. The process of claim 1, wherein precipitating the rare earth magnets to extract rare earth element sulfates further comprises:
precipitating the rare earth magnets in sodium hydroxide.

10. The process of claim 1, wherein precipitating the rare earth magnets to extract rare earth element sulfates further comprises:
precipitating the rare earth magnets in oxalic acid.

11. The process of claim 1, wherein precipitating the rare earth magnets to extract rare earth element sulfates further comprises:
calcining the rare earth magnets at high temperatures to form mixed rare earth oxides.

12. The process of claim 9, wherein the sodium hydroxide is added to bring the sulfuric acid solution pH above 2.

13. A process for efficient rare earth and critical material recovery from rare earth magnets, the process comprising:
demagnetizing the rare earth magnets;
breaking the rare earth magnets; and
leaching the rare earth magnets to extract rare earth element phosphates.

14. The process of claim 13, wherein demagnetizing the rare earth magnets comprises heating the rare earth magnets to a temperature between 350 degrees Celsius (° C.) to 450° C. for 0.5-3.0 hours.

15. The process of claim 13, wherein demagnetizing the rare earth magnets further comprises:
grinding or milling the rare earth magnets prior to demagnetizing the rare earth magnets.

16. The process of claim 13, wherein breaking the rare earth magnets further comprises at least one of grinding and milling the rare earth magnets.

17. The process of claim 13, wherein leaching the rare earth magnets to precipitate the rare earth phosphates further comprises:
leaching the rare earth magnets in phosphoric acid for 1-96 hours.

18. The process of claim 17, wherein the phosphoric acid is 2-4 molar (M) and at a liquid/solid ratio in the range of 30:1 to 35:1.

19. The process of claim 13 further comprising:
converting the rare earth element phosphates to oxides by heating the rare earth element phosphates with sodium carbonate.

20. The process of claim 19, wherein the rare earth element phosphates are heated to a temperature between 500° C. and 1300° C.
